(19) United States
(12) Patent Application Publication
(10) Pub. No.: US 2014/0067270 A1
(43) Pub. Date: Mar. 6, 2014

(54) WEATHER INFORMATION SYSTEM

(71) Applicant: Global Weather Corporation, Boulder, CO (US)

(72) Inventors: William B. Gail, Boulder, CO (US); William Loring Myers, Boulder, CO (US); Ted W. Post, Colorado Springs, CO (US)

(21) Appl. No.: 13/951,608

(22) Filed: Jul. 26, 2013

Related U.S. Application Data
(60) Provisional application No. 61/697,649, filed on Sep. 6, 2012.

(51) Int. Cl. G01W 1/00

(52) U.S. Cl. CPC G01W 1/00
USPC 702/3

(57) ABSTRACT

A method for providing weather information to a user is provided. The method includes steps of receiving a gridded forecast and receiving a user request for weather information for a location of interest within the gridded forecast. The method further includes steps of determining if updated sensor data is available for local grid points located proximate the location of interest. If updated sensor data is available, the method updates latest observation-based conditions at the local grid points. The method further includes a step of updating the weather information based on the updated sensor data and the gridded forecast.

### TECHNICAL FIELD

The embodiments described below relate to, weather forecasting systems, and more particularly, to a weather forecasting system that can provide improved geospatial and temporal weather information.

### BACKGROUND OF THE INVENTION

Weather forecasts are often provided with relatively course geospatial and temporal resolution. For example, users are often provided weather forecasts for the nearest major metropolitan area to their location of interest. Although the rate at which the forecasts are updated may vary, often, the forecasts are only updated hourly. Many forecasts that are delivered to end users are provided by the National Weather Service or other private vendors. While updating the forecast more often and/or reducing the geospatial distance between forecasted locations would be ideal, much of the information would go unused and thus, would result in an excessive amount of computation that is wasted. Consequently, weather forecasts are currently generated in “bulk”, meaning a system generates forecasts for many cities, for example 10,000 globally and does so hourly. Although some systems may update more often or include finer geospatial resolution, the forecasts generally do not update instantly or correspond to a user's specific location. Providing such fine resolution would be impractical in most situations. Imagine the computer power required to generate forecasts every minute at one meter spacing globally.

There exist certain situations where more detailed and refined weather information (current conditions or forecasts) is desired. The need for more detailed and updated weather information has become more prevalent with the increased use of mobile devices capable of receiving weather information over wireless internet connections or cellular connections. With the increased ability to receive instantaneous information, users continually desire weather information that is up to date and relevant to their specific location.

The prior art systems that are currently available simply provide a user with existing data from an existing forecast, such as one provided by the National Weather Service or one created by the prior art system without any input by the user and forward the existing data to users without providing additional computations to update the forecast. Therefore, the weather information provided to the user is relatively generic and may not provide the specificity desired by the user.

The embodiments described below overcome these and other problems and an advance in the art is achieved. The embodiments described below obtain a gridded forecast with a fixed geospatial resolution and preset refresh intervals. Upon receiving a user request for weather information for a particular location and timeframe, a new updated forecast is determined based on data from updated sensor inputs and interpolations between forecast locations provided by the gridded forecast.

### SUMMARY OF THE INVENTION

A method for providing weather information to a user is provided according to an embodiment. The method comprises steps of receiving a gridded forecast and receiving a user request for weather information for a location of interest within the gridded forecast. According to an embodiment, the method further comprises a step of determining if updated sensor data is available for local grid points located proximate the location of interest and if updated sensor data is available, updating latest observation-based conditions at the local grid points. According to an embodiment, the method further comprises a step of updating the weather information based on the updated sensor data and the gridded forecast.

A forecasting system including a processing system is provided according to an embodiment. The processing system is configured to receive a gridded forecast and receive a user request for weather information for a location of interest within the gridded forecast. According to an embodiment, the processing system is further configured to determine if updated sensor data is available for local grid points located proximate the location of interest and if updated sensor data is available, update latest observation-based conditions at the local grid points. According to an embodiment, the processing system is further configured to update the weather information based on the updated sensor data and the gridded forecast.

### Aspects

According to an aspect, a method for providing weather information to a user comprises steps of:
receiving a gridded forecast;
receiving a user request for weather information for a location of interest within the gridded forecast;
determining if updated sensor data is available for local grid points located proximate the location of interest;
if updated sensor data is available, updating latest observation-based conditions at the local grid points; and
updating the weather information based on the updated sensor data and the gridded forecast.

Preferably, the method further comprises a step of generating location specific weather information using spatial interpolation of the local grid points.

Preferably, the method further comprises a step of including topographical data when performing the spatial interpolation.

Preferably, the method further comprises a step of including climate data when performing the spatial interpolation.

Preferably, the method further comprises a step of refining the weather information based on temporal interpolation for a time of interest.

Preferably, the user's request is generated by a mobile device.

Preferably, the user request is automatically generated by the user's mobile device.

Preferably, the location of interest is based on a geospatial location of the user's mobile device.

Preferably, the location of interest is selected by the user.

Preferably, the step of receiving the gridded forecast occurs on a preset time interval.

According to another aspect, a forecasting system including a processing system is configured to:
receive a gridded forecast;
receive a user request for weather information for a location of interest within the gridded forecast;
determine if updated sensor data is available for local grid points located proximate the location of interest;
if updated sensor data is available, update latest observation-based conditions at the local grid points; and
update the weather information based on the updated sensor data and the gridded forecast.

Preferably, the processing system is further configured to generate location specific weather information using spatial interpolation of the local grid points.

Preferably, the processing system is further configured to include topographical data when performing the spatial interpolation.

Preferably, the processing system is further configured to include climate data when performing the spatial interpolation.

Preferably, the processing system is further configured to refine the weather information based on temporal interpolation for a time of interest.

Preferably, the user's request is generated by a mobile device.

Preferably, the user request is automatically generated by the user's mobile device.

Preferably, the location of interest is based on a geospatial location of the user's mobile device.

Preferably, the location of interest is selected by the user.

Preferably, receiving the gridded forecast occurs on a preset time interval.

### BRIEF DESCRIPTION OF THE DRAWINGS

FIG. 1 shows a forecasting system according to an embodiment.

FIG. 2 shows a grid used for a gridded forecast according to an embodiment.

FIG. 3 shows a process used to obtain improved forecasts according to an embodiment.

### DETAILED DESCRIPTION OF THE INVENTION

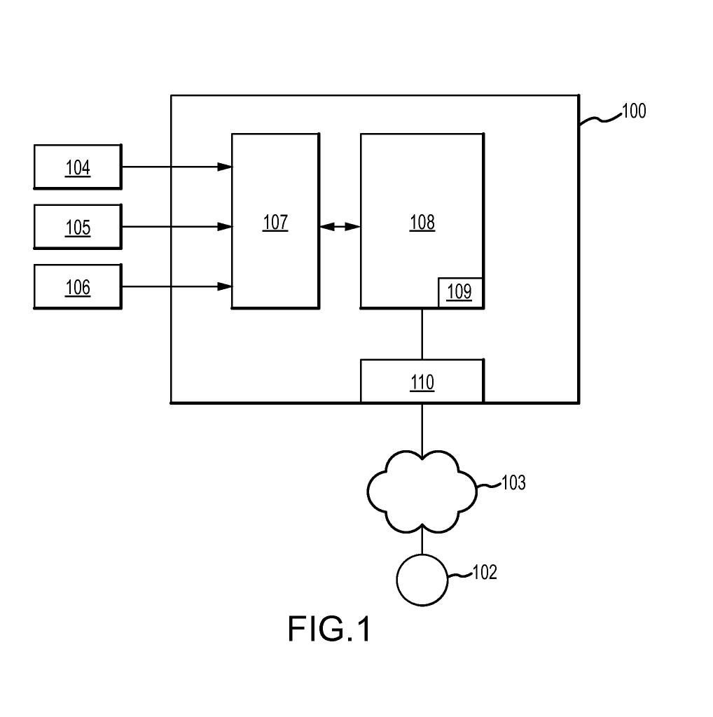

FIGS. 1-3 and the following description depict specific examples to teach those skilled in the art how to make and use the best mode of embodiments of a forecasting system. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the forecasting system. As a result, the embodiments described below are not limited to the specific examples described below, but only by the claims and their equivalents.

FIG. 1 shows a forecasting system 100 according to an embodiment. The forecasting system 100 can provide a user 102 with improved weather information over a network 103. As used in the present description and claims that follow, the weather information may comprise current weather conditions or may comprise weather forecast conditions. The weather information may comprise a variety of weather characteristics such as for example and not limitation, temperature, wind speed, wind direction, dew point, barometric pressure, humidity, UV level, visibility, cloud coverage, etc.

The network 103 may comprise an internet, intranet, cellular network, etc. The particular type of network 103 used is not important so long as the network allows the weather forecasting system 100 to communicate with the user 102 and vice versa.

According to an embodiment, the forecasting system 100 can receive weather data from one or more data sources 104-106. Although three data sources are shown in FIG. 1, it should be appreciated that any number of data sources may be used. According to an embodiment, one of the data sources 104 can comprise a forecasting data source 104, such as the National Weather Service or some other forecasting vendor. In some embodiments, the forecasting data source 104 may be provided by the same vendor operating the forecasting system 100, for example. The forecasting data source 104 can generate a gridded forecast and provide the gridded forecast to the forecasting system 100. By “gridded forecast”, it is meant that the weather data is separated into distinct regions, which may be divided into a grid. Each region includes weather data at distinct locations where sensors are located. The weather data may comprise current conditions and forecast conditions. In the prior art, the weather data was then used to generalize the forecast for the surrounding areas. Gridded forecasts are well known in the art and a more complete description is omitted for the sake of brevity of the description.

The forecasting system 100 can also receive weather data from other data sources 105, 106, which may comprise sensors such as radars, temperature sensors, barometers, wind sensors, etc. The sensors may be the same sensors used by the forecasting source 104 or may be different sensors. For example, if the sensors 105, 106 are the same sensors used by the forecasting source 104, the sensors 105, 106 can provide updated weather data that was not used to create the gridded forecast 200 received by the forecasting source 104. The other data sources 105, 106 may alternatively or additionally comprise a database of sensors. One exemplary database is the “Meteorological Assimilation Data Ingest System” (MADIS) that is operated by the National Oceanic and Atmospheric Administration. According to an embodiment, one of the data sources may also comprise a geographical data source that provides geographical data such as climate data, topographical data, etc. The use of geographical data is described in more detail below.

According to an embodiment, the weather data can be received by a data interface 107. The data interface 107 can receive the data from the one or more data sources 104-106 and perform any necessary processing, digitizing, etc. in order to be usable by the forecasting system's processing system 108.

The processing system 108 can receive the weather data along with the user's request and provide updated weather information to the user 102. The processing system 108 can comprise a general purpose computer, a micro-processing system, a logic circuit, a digital signal processor, or some other general purpose or customized processing device. The processing system 108 can be distributed among multiple processing devices. The processing system 108 can include any manner of integral or independent electronic storage medium, such as the internal memory 109. It should be appreciated that the processing system 108 may include many other components that are omitted from the drawings and discussion for the purpose of simplifying the description.

According to an embodiment, the forecasting system 100 can communicate with the user 102 via the network 103 through the network interface 110. The network interface 110 can provide any sort of communication interface necessary to decode information coming from the network 103 and code the information being sent through the network 103. The network 103 may comprise a wired network or a wireless network. Such network interfaces are generally known and the particular interface should in no way limit the scope of the embodiments claimed.

The particular components of the forecasting system 100 have been simplified for brevity of the description and many components have been omitted altogether. Those skilled in the art will readily appreciate that additional components may be provided without departing from the scope of the claims that follow.

As discussed above, the purpose of the forecasting system 100 is to provide updated weather information to users, which is both current and relevant to the user's particular requested location. According to an embodiment, while the forecasting system 100 updates the weather information for a user, the forecasting system 100 does not necessarily independently generate its own gridded forecast initially. In other words, the forecasting system 100 is not meant as a replacement for the National Weather Service. Rather, the forecasting system 100 improves upon the gridded forecasts provided by the external forecasting source 104.

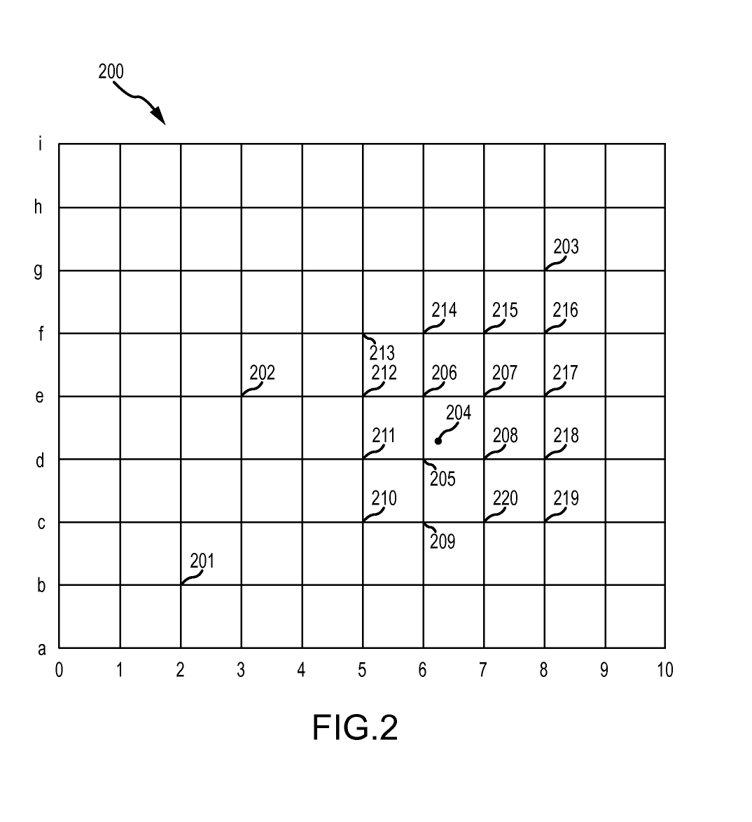

FIG. 2 shows an example grid 200 used for a gridded forecast provided by the forecasting source 104. The actual forecast is not shown in FIG. 2. Rather, an example grid 200 is provided to illustrate the need for the forecasting system 100. It should be appreciated, that while the grid 200 is shown with square grids, other shapes may be used. The grid 200 is separated into grids with numbers 0-10 going from left to right and a-i from bottom to top. According to an embodiment, each of the numbers and letters may be separated by a predetermined geospatial distance, such as one mile; however, other distances are certainly applicable. Furthermore, in some embodiments, the grid may not be separated perfectly evenly. When the forecasting source 104 provides a gridded forecast, only locations falling on the intersection lines are provided with forecast information. As examples, if a user requests forecast information at positions 201, 202, or 203, relevant forecast information will be available. In contrast, if a user is at location 204, there is no forecast information for that particular location. The closest forecast information would correspond to position 205. Although, this may provide adequate information for some users, many users desire finer forecast precision.

In addition to the relatively large geospatial separation between forecast locations, the forecasting source 104 only provides weather information at preset temporal intervals. For example, it is common for the forecasting source 104 to provide the gridded forecast once per hour. Depending on the particular user, more up to date current conditions and forecast conditions may be desired.

According to an embodiment, the forecasting system 100 can improve upon the gridded forecast provided by the forecasting source 104. Process 300 shows one approach to improving upon a gridded forecast according to an embodiment. Process 300 may be performed by the processing system 108 of the forecasting system 100, for example.

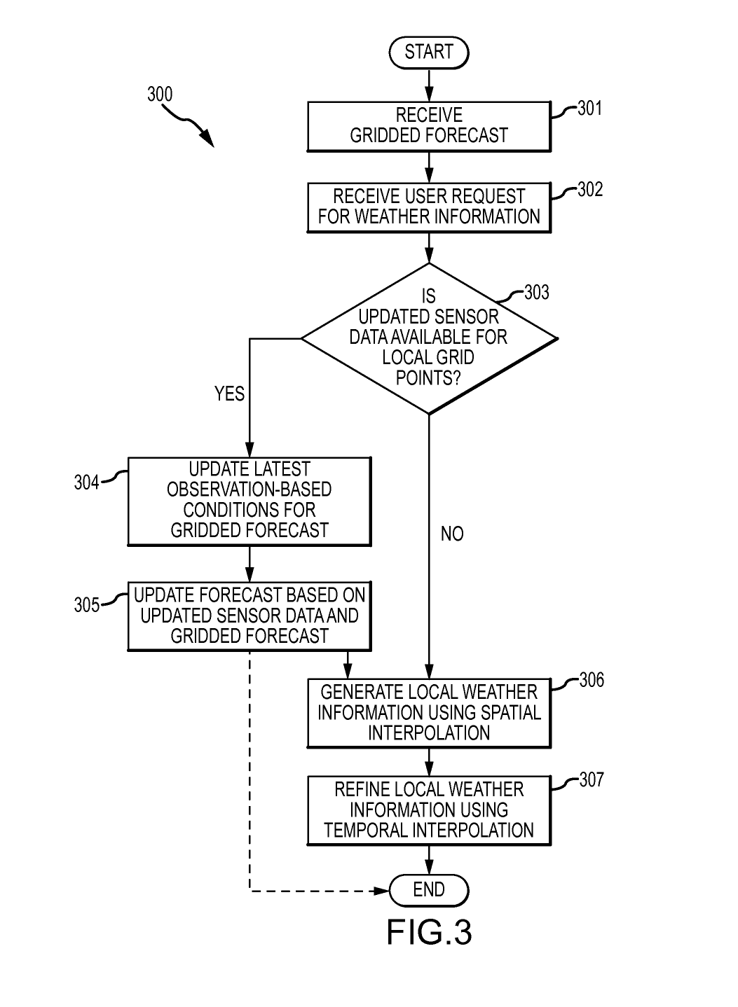

FIG. 3 shows the process 300 used to update and improve upon a gridded forecast according to an embodiment. According to an embodiment, the process 300 begins in step 301 where the gridded forecast is received from the forecasting source 104. The gridded forecast may be received according to a preset schedule, such as once per hour, for example. Alternatively, the gridded forecast may be received upon a request by the forecasting system 100. The gridded forecast can provide weather information for points that fall on the intersection lines of the grid 200 shown in FIG. 2, i.e., grid points. Therefore, the gridded forecast may provide a relatively course resolution as adjacent locations where relevant weather information is provided may be over a half mile away (using the scaling shown in FIG. 2). According to an embodiment, the forecasting system 100 may continue to receive the gridded forecast at the preset intervals without performing any further steps until step 302 when a user requests weather information.

In step 302, a user request for weather information at a location of interest is received. The requested weather information may be for current conditions or for future conditions. The requested information may be for a location of interest that lies on a grid point or for a location that lies between grid points. However, the location of interest must be within the gridded forecast. The user request may occur automatically by a user's processing system (not shown). For example, if the user 102 is using a mobile device, the mobile device's processing system may automatically request updated weather information at regular intervals or when the user 102 changes their location by a threshold distance. According to another embodiment, the user 102 may manually request updated weather information. For example, if a user 102 opens a weather application on their mobile device, the request may be sent to the forecasting system 100. It should be appreciated however, that the user request does not have to come from a mobile device and in other embodiments, the user request may come from a personal computer, or some other type of processing system.

According to an embodiment, the request for weather information may be based on a user's current location. The user's location may be manually entered or may be determined using a global positioning system associated with the user's device. It is well known that using triangulation, precise positioning of mobile devices can be determined. According to another embodiment, the request may be based on a user specified location, which may be different than the user's current location. For example, a user 102 may drop a pin on a map being shown or may simply tap the touch screen of their device. Therefore, the precise location of the weather information requested can be determined in multiple ways.

In addition to the location of the requested weather information, the request can include information as to the timing of the requested information. For example, the user 102 may request current conditions at the designated location. Alternatively or additionally, the user 102 may request a future forecast for weather conditions at the specified location.

According to an embodiment, once a user request is received, the process can continue to step 303 where the forecasting system 100 can determine if any updated sensor data is available. The sensor data may be obtained from a vendor such as MADIS, which is mentioned above. Alternatively, the sensor data may be obtained from individual weather sensors. According to an embodiment, the forecasting system 100 may only check for updated sensor data from neighboring weather sensors used to generate the weather information at local grid points. Local grid points comprise the grid points in an area surrounding the location specified by the user 102. For example, if the specified location is at point 204 shown in FIG. 2, the forecasting system 100 may only check for updated sensor data from the neighboring weather sensors used to generate the weather information at the local grid points of 205, 206, 207, and 208. In other words, the forecasting system 100 may only check for updated data for the immediately surrounding locations. According to another embodiment, the forecasting system 100 may expand the search for updated sensor data. For example, according to another embodiment, the forecasting system 100 may check for updated sensor data used to generate the weather information for the local grid points 205-220. Increasing the number of local grid points using updated sensor data may provide improved forecasting accuracy, but also requires excess processing time. Therefore, a tradeoff is made depending on how many local grid points are incorporated into the check for updated sensor data. However, it should be appreciated that the local grid points will be proximate the location of interest and comprise at least one grid point, but be less than the total number of grid points of the gridded forecast.

The updated sensor data corresponds to weather information that has become available since the most recently received gridded forecast, i.e., the latest observation-based conditions. As an example, one or more of the data sources 105, 106 used to generate the gridded forecast may provide data more often than the preset intervals in which the gridded forecast is produced. The forecasting system 100 can obtain the updated data in step 303.

According to an embodiment, if updated data is available, the process 300 can proceed to step 304 where the forecasting system 100 can update the received gridded forecast's latest observation-based conditions for the local grid points. In some embodiments, the latest observation-based conditions may correspond to the current conditions. However, in most embodiments, there will be a delay between the time the user 102 requests current conditions and when the latest updated sensor data had become available. The updated latest observation-based conditions can be used to update the current conditions at the location of interest, update the regularly scheduled forecast for the location of interest, or provide a new forecast at a user specified time for the location of interest as described in more detail below.

According to an embodiment, with the gridded forecast's observation-based conditions updated, the process 300 can continue to step 305 where forward error correction can be performed for the forecast for the local grid points using the updated sensor data and the gridded forecast. Step 305 can therefore, provide an updated future forecast for the local grid points based on the updated observation-based conditions. According to one embodiment, the updated future forecast may simply replace the forecast for the preset time intervals. As an example, a user 102 may make a request for a forecast at location 204 for the next 72 hours and the request may be received at 10:25 AM. Because the gridded forecast received in step 301 is only updated hourly, the gridded forecast was last updated at 10:00 AM. Therefore, in the prior art, any forecast request received between 10:00 AM and 10:59 AM will be the same. However, using the present embodiment, with a request received at 10:25 AM, the forecasting system 100 can update the latest observation-based conditions for the local grid points in step 304 and then update the forecast for the next 72 hours based on the received gridded forecast and the new sensor data in step 305. As mentioned above, the latest observation-based conditions may comprise updated sensor data that was received prior to the user request, such as at 10:20 AM, for example. However, the latest observation-based conditions are still updated compared to the data used to generate the gridded forecast received in step 301. According to the forward error correction, the forecasting system 100 ensures that the forecast matches the latest observation-based conditions at the local grid points as provided for in step 304. The updated forecast provided in step 305 is thus more accurate and more up to date than the gridded forecast received in step 301. The updated forecast can be determined using methods that are currently known in the art based on existing weather information.

According to an embodiment, process 300 may end after step 305 and provide the user 102 with an updated gridded forecast for the local grid points using the most current sensor data. Such an approach would provide an advantage over the prior art, which only provides an updated forecast hourly even though weather data regarding current conditions may be reported more frequently. However, as mentioned above, even the updated gridded forecast is limited in its geospatial applicability and the updated gridded forecast still provides a forecast at preset intervals (although it uses updated sensor data). Therefore, in some embodiments, the process 300 may continue to step 306. It should be appreciated, that the process 300 may also reach step 306 if there was no updated sensor data available in step 303.

In step 306, a local forecast can be generated using spatial interpolation. The spatial interpolation can be used to provide a more precise forecast for the location of interest using the local grid points from the gridded forecast or the updated gridded forecast. According to an embodiment, the local forecast can be applied to all of the available forecast times, such as each upcoming hour for the duration of the forecast available. The spatial interpolation may comprise a linear interpolation, a spline interpolation, a nearest neighbor interpolation, etc. The particular type of spatial interpolation used may depend on the particular specified location and its proximity to local grid points. According to some embodiments, in addition to the forecast information at the local grid points, step 306 may include additional climate and/or topographical data mentioned above. Incorporating the additional data can provide more accurate weather information by accounting for changes in elevation or slope facing directions. Therefore, step 306 can essentially provide unique weather information for any location within the local grid points.

In addition to spatial interpolation of the local grid points in step 306, temporal interpolation can also be used in step 307. Temporal interpolation can provide updated weather information in addition to the updated sensor information. The temporal interpolation may be used to provide updated current weather information to the user and/or may be used to provide updated forecast weather information for times that fall between the preset interval forecast provided above. Using the example above where a user 102 requests weather information at 10:25 AM, the updated sensor information may have corresponded to sensor information updated at 10:20 AM. Therefore, while the future forecast information is updated compared to the gridded forecast provided at 10:00 AM, the conditions at 10:25 AM are still not available. However, in step 307, a temporal interpolation can be made based on the updated sensor data received at 10:20 AM and the forecast predicted for 11:00 AM, for example. Using the temporal interpolation, a better estimate of the current conditions at 10:25 AM can be determined and provided to the user 102. According to an embodiment, the temporal interpolation can be purely mathematical using either linear or spline interpolation, for example.

According to another embodiment, the temporal interpolation can be used to provide the user with a forecast at a future time that falls between the preset interval forecast provided above. For example, if the user 102 requests weather information at 10:25 AM as above, but wants to know the forecast for 10:50 AM, a temporal interpolation can be made based on the updated sensor data received at 10:20 AM and the forecast predicted for 11:00 AM. Therefore, the temporal interpolation does not have to provide current conditions to the user 102.

At the end of the process 300, the updated weather information (forecast and current conditions) can be provided to a user 102. As can be appreciated, the updated weather information can be more accurate and local than in the prior art. Rather than relying upon data that may be up to an hour old, the embodiments discussed above can provide a user 102 with updated weather information that is relevant to their specific location.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other forecasting systems, and not just to the embodiments described above and shown in the accompanying figures. Accordingly, the scope of the embodiments described above should be determined from the following claims.

We claim:

1. A method for providing weather information to a user, comprising steps of:
receiving a gridded forecast;
receiving a user request for weather information for a location of interest within the gridded forecast;
determining if updated sensor data is available for local grid points located proximate the location of interest;
if updated sensor data is available, updating latest observation-based conditions at the local grid points; and
updating the weather information based on the updated sensor data and the gridded forecast.

2. The method of claim 1, further comprising a step of generating location specific weather information using spatial interpolation of the local grid points.

3. The method of claim 2, further comprising a step of including topographical data when performing the spatial interpolation.

4. The method of claim 2, further comprising a step of including climate data when performing the spatial interpolation.

5. The method of claim 1, further comprising a step of refining the weather information based on temporal interpolation for a time of interest.

6. The method of claim 1, wherein the user's request is generated by a mobile device.

7. The method of claim 6, wherein the user request is automatically generated by the user's mobile device.

8. The method of claim 6, wherein the location of interest is based on a geospatial location of the user's mobile device.

9. The method of claim 1, wherein the location of interest is selected by the user.

10. The method of claim 1, wherein the step of receiving the gridded forecast occurs on a preset time interval.

11. A forecasting system (100) including a processing system (108) configured to:
receive a gridded forecast;
receive a user request for weather information for a location of interest within the gridded forecast;
determine if updated sensor data is available for local grid points located proximate the location of interest;
if updated sensor data is available, update latest observation-based conditions at the local grid points; and
update the weather information based on the updated sensor data and the gridded forecast.

12. The forecasting system (100) of claim 11, wherein the processing system (108) is further configured to generate location specific weather information using spatial interpolation of the local grid points.

13. The forecasting system (100) of claim 12, wherein the processing system (108) is further configured to include topographical data when performing the spatial interpolation.

14. The forecasting system (100) of claim 12, wherein the processing system (108) is further configured to include climate data when performing the spatial interpolation.

15. The forecasting system (100) of claim 11, wherein the processing system (108) is further configured to refine the weather information based on temporal interpolation for a time of interest.

16. The forecasting system (100) of claim 11, wherein the user's request is generated by a mobile device.

17. The forecasting system (100) of claim 16, wherein the user request is automatically generated by the user's mobile device.

18. The forecasting system (100) of claim 16, wherein the location of interest is based on a geo spatial location of the user's mobile device.

19. The forecasting system (100) of claim 11, wherein the location of interest is selected by the user.

20. The forecasting system (100) of claim 11, wherein receiving the gridded forecast occurs on a preset time interval.
